(19) United States
(12) Patent Application Publication
(10) Pub. No.: US 2004/0080720 A1
(43) Pub. Date: Apr. 29, 2004

(54) Desk provided with projector

(75) Inventor: Masami Saito, Tokyo (JP)

Correspondence Address: YOUNG & THOMPSON, 745 SOUTH 23RD STREET 2ND FLOOR, ARLINGTON, VA, 22202

(73) Assignee: NEC VIEWTECHNOLOGY LTD, TOKYO (JP)

(21) Appl. No.: 10/668,219

(22) Filed: Sep. 24, 2003

(30) Foreign Application Priority Data
Sep. 27, 2002 (JP) 2002-284180

(51) Int. Cl. G03B 21/14

(52) U.S. Cl. 353/79

(57) ABSTRACT

A projector and an aspherical mirror are arranged below a top of a desk. Lights outputted from the projector are reflected on the mirror and projected on a screen in front of the desk. The reflected lights by the mirror transmit a transparent plate arranged in a part of the top of the desk. The reflected lights can be adjusted to pass in front of the desk. The projector is movable to be contained directly under the desk. The desk is provided with casters, therefore distance between the desk and the screen is adjusted to thereby enlarge the size of a projected picture on the screen.

### BACKGROUND OF THE INVENTION

1. Field of the Invention

The present invention relates to a desk provided with a projector, particularly relates to a desk provided with a projector that displays an image on a screen in front of the desk.

2. Description of the Related Prior Art

A computer CRT monitor device with a size of about 21 to 25 inches is usually used for design operations (e.g. Computer-Aided Design (CAD)). When the CTR monitor of this size is placed on a work desk, a large space of the desk is occupied. In recent years, since information quantity to be processed in CAD operations is increased, a larger display is desired. However, it is difficult to place a larger CRT monitor device on the work desk. On the other hand, in recent years, a large-sized plasma display and a liquid crystal display has been developed. These displays are formed in planar shape, to thereby save the occupancy space. However, the plasma display requires high power consumption and the liquid crystal display is expensive.

Japanese Patent Laid-open No.08-062722 discloses a projected picture of a projector which is used as a display for CAD operations. This projector serves as a rear projection type projector for projecting a picture to the rear of the desk, and the 40 to 50-inch display is realized. According to the rear projection type projector, lights outputted from the projector are usually reflected on a plurality of mirrors and projected on the screen of the desktop. Accordingly, the work desk including these projector and mirrors becomes larger. Also, since the major part of a screen are arranged in a position higher than the position of an operator's eyes, an operator's work efficiency falls.

### SUMMARY OF THE INVENTION

The present invention proposes a desk provided with a projector which is disposed below the top of a desk. Lights outputted from the projector are reflected on a mirror and projected in front of the desk. It is preferable to use an aspherical mirror. A part of the top of the desk can be a transparent plate where the lights outputted from the projector transmit. All of the lights outputted from the projector can pass in front of the top of a desk. In this case, a part of the top of a desk can be cut off. The projector can be disposed in such a manner as to be protruded from the depth of the top of a desk. In this case, the projector can be moved or rotated to be disposed below the top of a desk. The lights outputted from the projector are projected on the screen disposed in front of the desk. The size of a picture projected on the screen is varied according to the position of the screen.

By using the above-described desk provided with a projector, it becomes possible to form a large projected picture at the position close to an operator and also at an easy-to-view position.

### BRIEF DESCRIPTION OF THE DRAWINGS

The above and other objects, features and advantages of the present invention will become apparent from the following detailed description when taken with the accompanying drawings in which:

FIG. 1A, FIG. 1B and FIG. 1C are respectively a plan view, a side view, and a front view of examples of a desk provided with a projector;

FIG. 2 is a plan view showing an example of a top of a desk;

FIG. 3 is an exemplified graph of a projection characteristic of a projector shown in FIGS. 1A-1C;

FIG. 4A and FIG. 4B are a side view and a front view respectively showing examples of the arrangement of a desk and a screen;

FIG. 5A, FIG. 5B and FIG. 5C are a side view, a front view, and a plan view respectively showing the arrangement of a desk and a monitor in conventional examples and examples of this invention;

FIGS. 6A, 6B, and 6C are a side view, a front view, and a plan view of a desk provided with a projector in another example;

FIG. 7 is a side view showing a desk in another example;

FIG. 8A and FIG. 8B are a side view and a front view respectively showing examples of arrangement of a desk, a screen, and a projected picture;

FIG. 9 is a side view showing an example of a desk having a projector contained therein;

FIG. 10A and FIG. 10B are plan views showing examples of a CAD room; and

FIG. 11A and FIG. 11B are plan views showing examples of use of a desk provided with a projector of this invention.

### DETAILED DESCRIPTION OF THE PREFERRED EMBODIMENTS

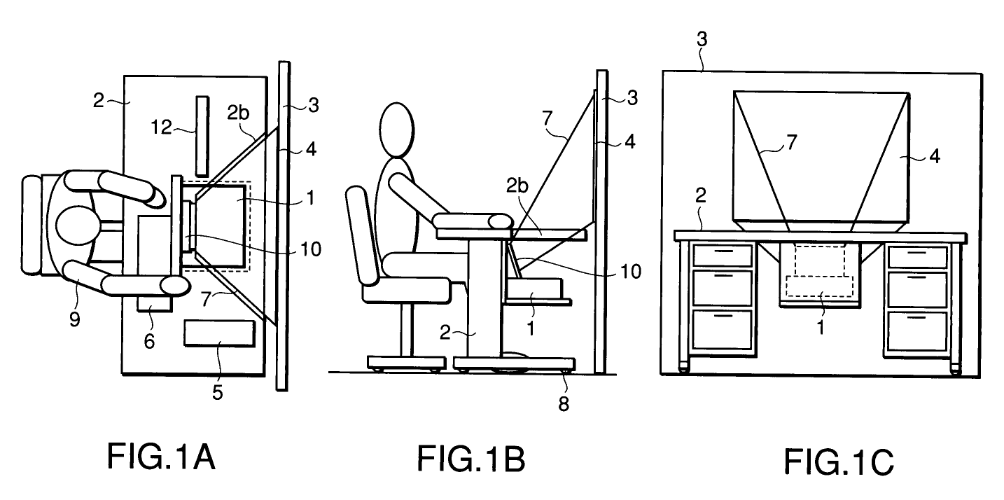

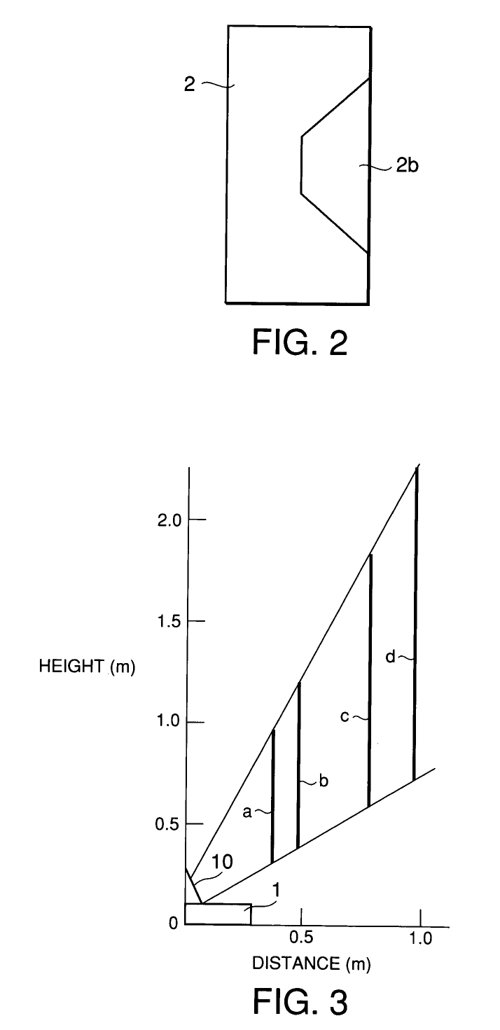

According to FIG. 1A, FIG. 1B, and FIG. 1C, a plan view (FIG. 1A), a side view (FIG. 1B), and a front view (FIG. 1C) of a desk provided with a projector are shown. A computer 5, a keyboard 6, and a liquid crystal monitor 12 are arranged on a top of a desk 2. The desk 2 has the depth of 70 cm. A projector 1 and an aspherical mirror 10 are arranged below the top of the desk 2. The computer 5 is connected to the projector 1 via a cable. An operator 9 inputs the information to be displayed on a projected picture 4 with a keyboard 6. A part of the top of the desk 2 is a trapezoidal transparent plate 2b. Lights 7 reflected on the aspherical mirror 10 transmit the transparent plate 2b and forms the projected picture 4 on a screen 3 in front of the desk 2. The screen 3 can be made of a suitable sheet which is stuck to a regular partition used in an office, for example. When the desk 2 and the partition are set up in a state of close contact with each other, lights 7 outputted from the projector 1 transmit the above-described trapezoidal transparent plate 2b and forms a 40-inch projected picture 4 on this screen. The leg part of the desk 2 includes a caster, to thereby adjust the distance between the desk 2 and the screen 3. FIG. 2 is a plan view showing an example of the top of the desk 2. The transparent plate that allows the lights to transmit the trapezoid part 2b of the top of the desk 2 is arranged. It is possible not to select the transparent plate to be arranged in the trapezoid part. In this case, the top of the desk 2 is so shaped that the trapezoid part is cut off, and the lights reflected on the aspherical mirror 10 can pass the cut-off trapezoid part.

FIG. 3 is a graph of an example of the characteristic of the projector 1. The ordinate of the graph shows the height of the projected picture on the basis of the bottom of the projector 1. The abscissa of the graph shows the distance from the rear face of the projector 1 to the projected picture. The vertical lines a, b, c, and d in the graph show vertical width of the projected picture. The vertical lines a, b, c, and d correspond to 40-inch, 50-inch, and 80-inch, and 100-inch projected pictures respectively. In this example of characteristic, if projection distance increases by 1 cm, the size of the projected picture becomes large by about 1 inch. In addition, the projected picture is shifted upwards as a screen size becomes large. By changing the design specification of an optical system including the aspherical mirror, it is possible to further shorten the projection distance or change the angle of projection. In order to obtain the above-described characteristic, the optical system including the aspherical mirror is most preferable. However, the same characteristic as the above characteristic can be achieved even in the optical system without using the aspherical mirror, provided that structure of the projector, arrangement and type of a lens are changed.

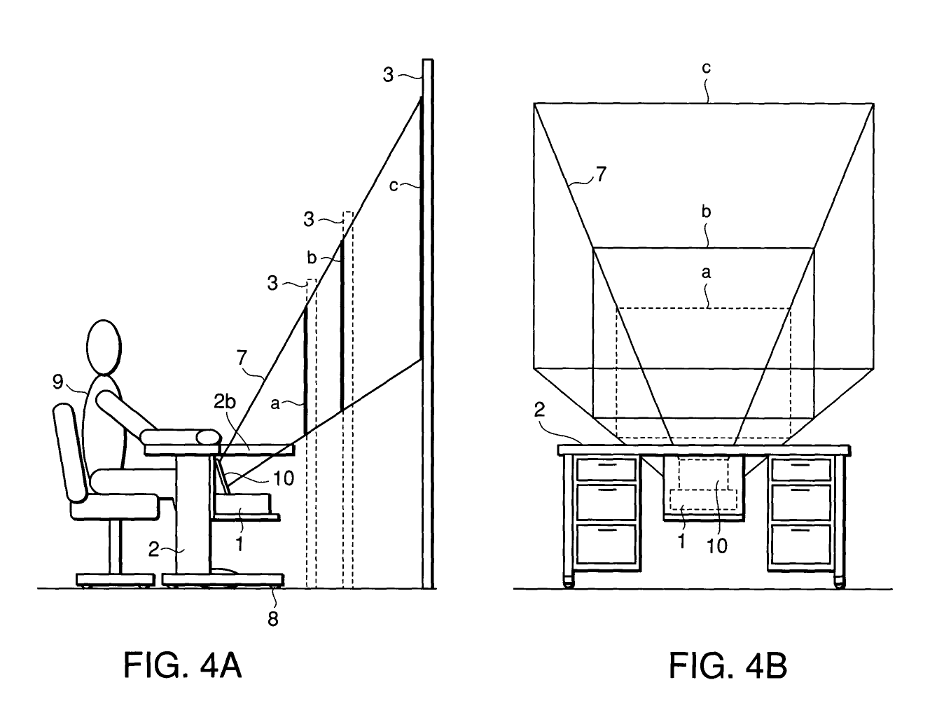

FIG. 4A and FIG. 4B show examples of position relations of the desk 2, the operator, and the screen 3. Lights 7 outputted from the projector 1 and reflected on the aspherical mirror 10 form a projected picture on the screen 3. In the case of the 40-inch projected picture (a), the major part of the projected picture is formed in a position lower than the position of the operator's eyes. In the case of the 50-inch projected picture (b), the height of the central part of the projected picture is substantially in agreement with the position of the operator's eyes. In the case of the 80-inch projected picture (c), the major part of the projected picture is formed in a position higher than that of the operator's eyes. In the examples, any projected picture is formed in a position higher than that of the top of the desk.

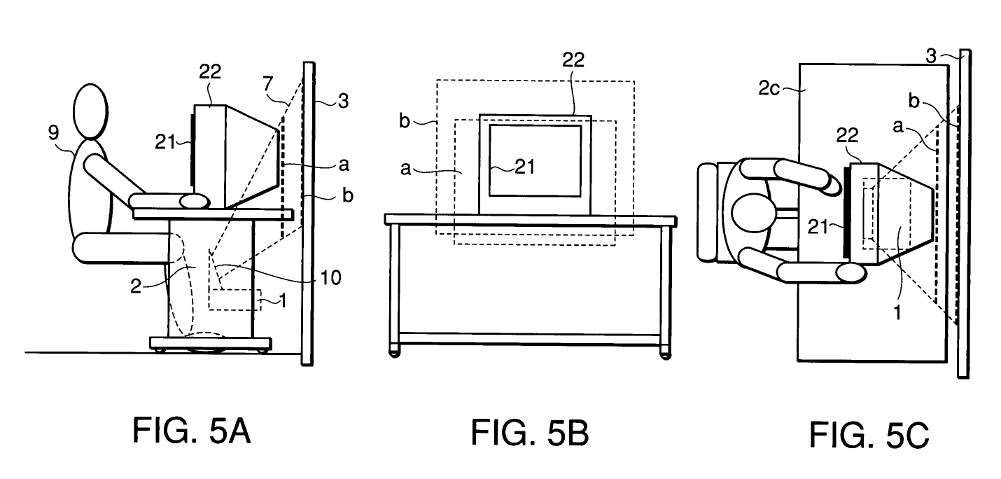

According to FIG. 5A, FIG. 5B, and FIG. 5C, a CRT monitor 22 including a 21-inch display 21 is set up on the desk 2. The CRT monitor 22 is long in its depth, therefore the position of the operator 9 becomes very close to the display 21. In addition, these figures show that lights 7 projected from the projector 1 via the aspherical mirror form a 40-inch (a) and 50-inch (b) projected picture on the screen 3 as well. The projector 1 set up in the desk of the same size with the conventional desk can form a large picture easily.

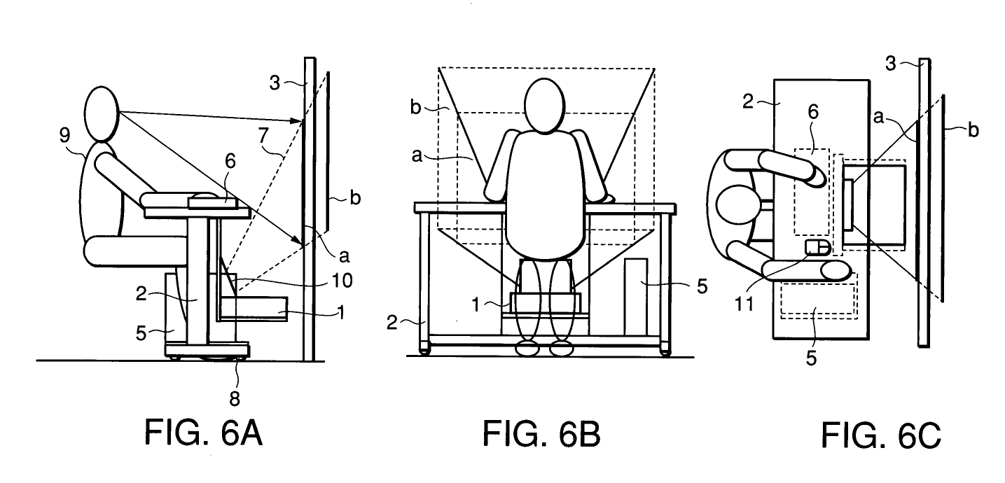

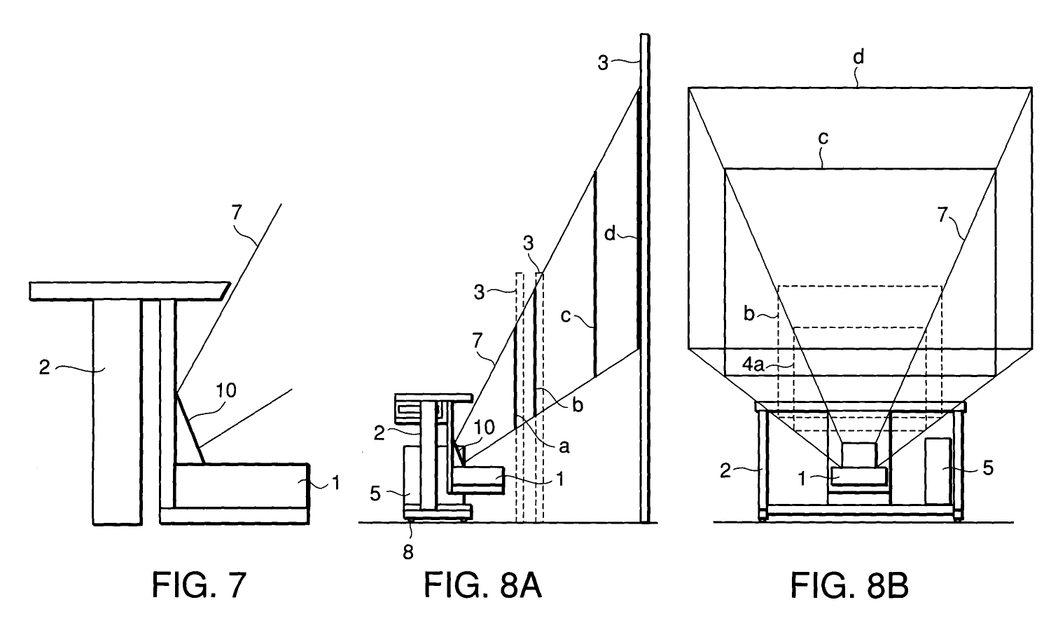

FIG. 6A, FIG. 6B, and FIG. 6C show another example of this invention. A computer 5 is disposed below the top of the desk 2. On the top of the desk 2, a keyboard 6 and a mouse 11 are arranged. In this example, the depth of the desk 2 is shorter compared with that of the desk 2 shown in FIG. 1A, FIG. 1B, and FIG. 1C. The projector 1 is not disposed directly under the top of the desk 2, but a part of the projector 1 is disposed in front of the top of the desk 2. The lights outputted from the projector 1 are reflected by the aspherical mirror 10 and passes in front of the desk 2 without interrupted by the desk 2 to form a projected picture a (or b) on the screen 3. In this example, a part of the projected picture a and the projected picture b is located lower than the height of the top of the desk 2. For this reason, a work load on the operator is relieved. In addition, as shown in FIG. 7, the front edges of the top of the desk 2 where the reflected lights 7 pass can be formed into tapered shapes.

FIG. 8A and FIG. 8B show examples of the position relation of the desk 2 shown in FIGS. 6A, 6B, and 6C, the screen 3, and the projected picture. If the size of the projected picture is 40 inches (a), or 50 inches (b), apart of the projected picture is formed in a position lower than the top of the desk 2. If the size of the projected picture is 80 inches (c), or 100 inches (d), the projected picture is formed in a position higher than the top of the desk 2.

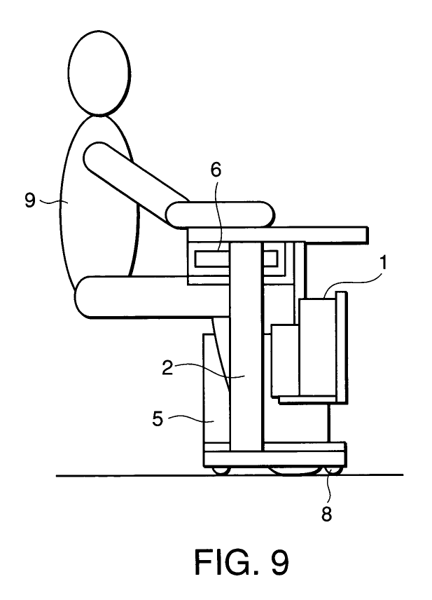

According to FIG. 9, the projector 1 and the keyboard 6 are contained in the desk 2. The keyboard 6 is contained in a container box disposed directly under the top of the desk 2, and the projector 1 is rotated by 90 degrees to be contained below the top of the desk 2 without protruding from the top of the desk 2. It is also possible to design so that the projector 1 may be transferred in parallel to be contained under the top of the desk 2. If the projector 1 is contained in this way, the desk 2 can be used as a usual office desk.

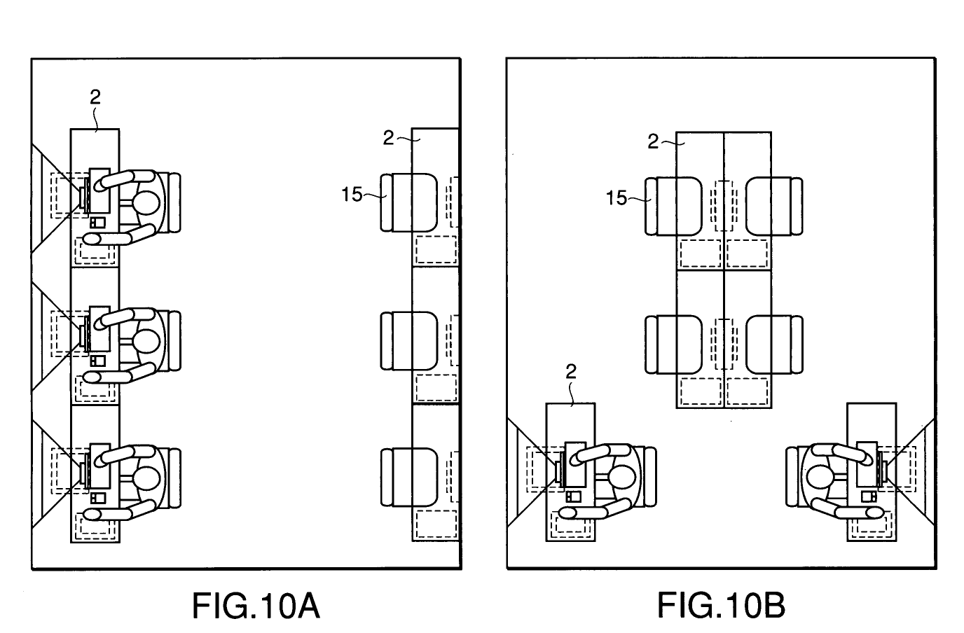

According to FIG. 10A and FIG. 10B, a plan view of a room in which a CAD operator works is shown. When the desk 2 is not used for CAD operations, the projector 1 is contained under the top of a desk 2. In this case, the desk 2 can be used for a usual office desk or a desk for a meeting.

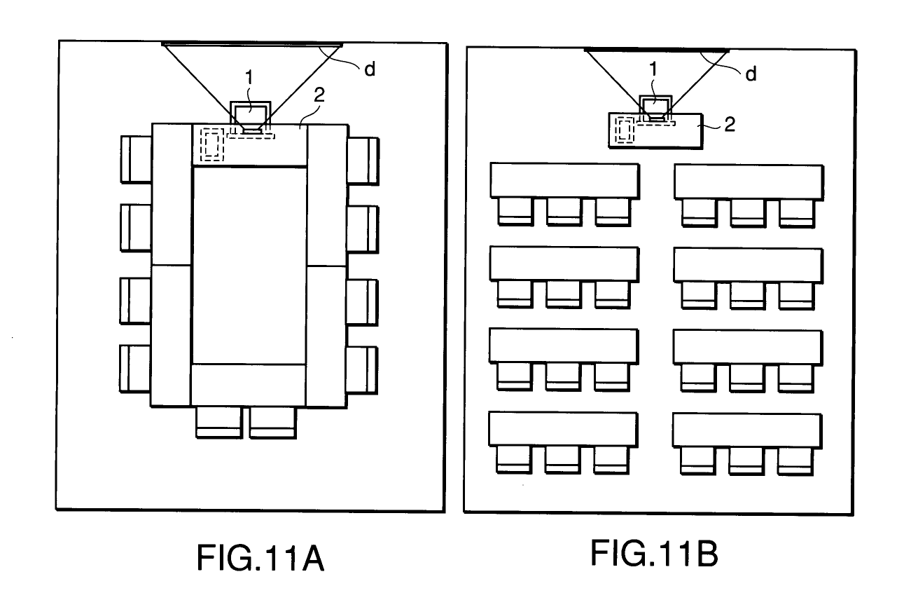

FIG. 11A and FIG. 11B show a case where the desk 2 provided with the projector 1 is used in a conference room and a seminar room. The 100-inch picture (d) is projected on the wall in front of the room.

According to this invention, the size of the projected picture can be adjusted by changing the distance between the desk 2 and the screen 3. Also, the picture can be enlarged when the computer 5 is controlled. Focus adjustment of the projected picture is possible when an optical system such as a lens or a mirror is adjusted.

The above-described projector is short in projection distance and large in projection angle. Therefore, a large projected picture can be easily formed in a position close to the operator. A desk provided with this projector can be used for various situations other than the CAD operations.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A desk provided with a projector, wherein the projector is arranged below a top of the desk, and lights outputted from the projector are reflected by a mirror and projected in front of the desk.

2. The desk according to claim 1, wherein the mirror is an aspherical mirror.

3. The desk according to claim 1, wherein a part of the desk is a transparent plate and the lights outputted from the projector pass the transparent plate.

4. The desk according to claim 1, wherein all of the lights outputted from the projector pass in front of the top of the desk.

5. The desk according to claim 4, wherein a part of the top of the desk is cut off.

6. The desk according to claim 1, wherein the projector is so arranged as protruding from the depth of the top of the desk.

7. The desk according to claim 6, wherein the projector is movable and arranged under the top of the desk.

8. The desk according to claim 6, wherein the projector is rotatable and arranged below the top of the desk.

9. The desk according to claim 1, wherein the lights outputted from the projector are projected on a screen arranged in front of the desk.

10. The desk according to claim 9, wherein the size of the picture projected on the screen is varied according to a set-up position of the screen.

11. The desk according to claim 9, wherein a part of the picture projected on the screen is positioned below the top of the desk.

12. The desk according to claim 9, wherein a computer that inputs information to be projected on the screen is provided.

13. The desk according to claim 12, wherein an operator operates the computer to perform Computer-Aided Design.
